(19) United States
(12) Patent Application Publication
(10) Pub. No.: US 2016/0079601 A1
(43) Pub. Date: Mar. 17, 2016

(54) CATHODE MATERIAL FOR SECONDARY BATTERIES, METHOD FOR PRODUCING CATHODE MATERIAL FOR SECONDARY BATTERIES, AND SECONDARY BATTERY

(71) Applicant: MITSUI ENGINEERING & SHIPBUILDING CO., LTD., Tokyo (JP)

(72) Inventors: Hideya YOSHITAKE, Yonezawa-shi (JP); Masaki YOSHIO, Yonezawa-shi (JP); Naoki HATTA, Ichihara-shi (JP); Wataru IWABUCHI, Ichihara-shi (JP); Noriyuki SHIMOMURA, Ichihara-shi (JP)

(73) Assignee: MITSUI ENGINEERING & SHIPBUILDING CO., LTD., Tokyo (JP)

(21) Appl. No.: 14/891,211

(22) PCT Filed: May 14, 2014
(86) PCT No.: PCT/JP2014/062866

§ 371 Date: Nov. 13, 2015

(30) Foreign Application Priority Data
May 15, 2013 (JP) 2013-103567

(51) Int. Cl. H01M 4/62; H01M 10/0525; H01M 4/525; H01M 4/58; H01M 4/505

(52) U.S. Cl. CPC H01M 4/624; H01M 4/5825; H01M 4/505; H01M 4/525; H01M 10/0525

(57) ABSTRACT

A cathode material for Li ion secondary batteries has high output and high energy density with excellent electron conductivity and Li ion conductivity. The cathode material contains an electrode active material base containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g. Surfaces of primary particles of an electrode active material base are coated with a layer containing a conductive polymer and a negative ion that enables the conductive polymer to produce electron conductivity equal to or higher than the electron conductivity of the electrode active material itself.

### CROSS-REFERENCE TO RELATED PATENT APPLICATIONS

This application is a U.S. National Phase Application under 35 U.S.C. §371 of International Patent Application No. PCT/JP2014/062866, filed May 14, 2014, and claims the benefit of Japanese Patent Application No. 2013-103567, filed on May 15, 2013, all of which are incorporated by reference in their entirety herein. The International Application was published in Japanese on Nov. 20, 2014 as International Publication No. WO/2014/185460 under PCT Article 21(2).

### FIELD OF THE INVENTION

The present invention relates to a cathode material capable of being used for lithium ion secondary batteries or the like, a method for producing the same, and a secondary battery such as a lithium ion secondary battery, which includes the cathode material as a constituent member.

### BACKGROUND OF THE INVENTION

Electrode active materials such as metal phosphates having an olivine crystal structure, metal oxides having a spinel crystal structure, and metal oxides having a layered crystal structure have been used as an electrode material for lithium ion secondary batteries or the like. The electron conductivity and ion conductivity of such electrode active materials are preferably higher. Therefore, in order to improve the electron conductivity and ion conductivity, Patent Literatures 1 and 2, for example, disclose an electrode material having a layer of conductive carbon.

Further, Patent Literature 3 discloses an electrode material having a composite thin layer made of conductive carbon and a lithium ion conductor.

Still further, Patent Literature 4 discloses an electrode material having a conductive polymer such as polyaniline, and Non-patent Literature 1 discloses lithium iron phosphate coated with polythiophene.

### CITATION LIST

### Patent Literatures

Patent Literature 1: JP 2001-15111 A
Patent Literature 2: JP 2004-509447 A
Patent Literature 3: WO 2012/133566 A
Patent Literature 4: JP 2005-340165 A

### Non-Patent Literature

Non-patent Literature 1: Journal of Alloys and Compounds 508 (2010) 1-4

### PROBLEMS TO BE SOLVED BY THE INVENTION

At present time, electrode active materials (cathode active materials) that have been commercialized include lithium cobalt oxide (LiCoO₂) having a layered crystal structure, lithium nickel cobalt oxide (LiNi_{α}Co_{1-α}O₂), lithium nickel cobalt aluminum oxide (LiNi_{α}Co_{β}Al_{1-α-β}O₂) and lithium nickel cobalt manganese oxide (LiNi_{α}Co_{β}Mn_{-α-β}O₂), which are obtained by substituting apart of cobalt of lithium cobalt oxide with nickel or the like, and lithium manganese oxide (LiMn₂O₄) and the like, which have a spinel crystal structure. All of these are cathode active materials having an average redox potential of about 3.7 to 4.1 V based on a metal Li negative electrode and are practically generally charged and oxidized often at an upper limit potential up to about 4.3 to 4.5 V based on a metal Li negative electrode.

By charging and oxidizing to a higher potential, in general, a charge/discharge capacity can be increased and also a charging time can be shortened. A reason for limiting a charging potential on purpose is that during charging at a high voltage, side reactions such as oxidative decomposition of a cathode material itself and an electrolyte solution on a surface of the cathode material, and elution of a transition metal component in the cathode material into the electrolyte solution occur, and the characteristics of the battery are likely to be degraded.

Further, recently, in order to improve the input/output density and energy density of a battery, a practical application of, for example, LiNi_{0.5}Mn_{1.5}O₄, LiCoPO₄ and the like as a cathode material, which have a very high redox potential such as exceeding 4.5 V based on a metal Li negative electrode is considered. When these high-voltage cathode materials are used, it is necessary to charge and oxidize at a very high upper limit potential such as about 5 V based on a metal Li negative electrode. Therefore, even when the oxidative decomposition of the electrode active material itself can be suppressed by a composition improvement and so on, it is difficult to avoid to suppress side reactions such as the oxidative decomposition of the electrolyte solution and the elution of the transition metal component in the cathode material into the electrolyte solution. In particular, generation of oxidizing gases such as oxygen due to the oxidative decomposition of the electrolyte solution or the cathode material itself may induce an uncontrolled combustion of an organic electrolyte solution usually having flammability.

On the other hand, the electron conductivity and/or ion conductivity can be increased and the charge/discharge capacity and output characteristics can be improved by adopting coating techniques on surfaces of particles of the cathode active material such as disclosed in the Patent Literatures 1 to 4 and the Non-patent literature 1, which were described above. However, an influence on safety of the secondary batteries by these conventional modification technologies of compositing has not been considered so much.

In actuality, due to the coating layers disclosed in the literatures described above, a direct contact between the cathode material and the electrolyte solution can be partly avoided. Therefore, while it is considered that there is a slight suppression effect on the side reactions described above, a degree of the improvement was insufficient. This is because the coating layers disclosed in the literatures described above have porous characteristics with many defects.

The coating layers disclosed in the Patent Literatures 1 to 4, for example, are mostly formed of carbon generated by the thermal decomposition of precursors such as organic materials. The relevant carbon is brittle and not dense, and through many structural defects that are actually present, the electrolyte solution permeates into the carbon coating layer, and the electrolyte solution comes into direct contact with surfaces of the particles of the electrode active material.

Further, in the Non-patent Literature 1, polythiophene (PTh) is precipitated on a LiFePO₄ electrode active material by oxidative polymerization as a conductive coating layer other than carbon. At this time, a dipping solution in which an oxidant and a polymerizing monomer are dissolved together is brought into contact with the electrode active material. Therefore, in a resulting cathode material, it is assumed that amorphous powdery PTh is only deposited on an electrode active material and not dense because a polymerization reaction occurs not on surfaces of particles of the electrode active material but mainly in an inside (bulk) of the dipping solution.

Further, in the coatings of the electrode active material with carbon or the like generated by the thermal decomposition of a carbon precursor such as organic materials, which are disclosed in the Patent Literatures 1 to 3, it is presumed to be carried out in a non-oxidizing atmosphere such as inert gas to avoid combustion loss of carbon by oxidation. However, in the case of LiNi_{0.5}Mn_{1.5}O₄ active material described above, for example, when it is sintered at high-temperatures in such an atmosphere, bound oxygen atoms in the active material are dissociated and oxygen defects are increased; as a result, there occurs a problem that the redox capacity in the vicinity of the 4.7 V decreases. Thus, a method of imparting the electron conductivity by a thermally decomposed carbon coating cannot be adopted in a cathode active material that is thermochemically unstable in the non-oxidizing atmosphere. Further, since the cathode active materials like this are usually synthesized by sintering in an oxidizing gas atmosphere such as in air, the sintering synthesis of the cathode active material and the coating of the cathode active material with the thermally decomposed carbon cannot be simultaneously performed, that is, both processes are difficult to be adapted.

An object of the present invention is to provide a high output and high energy density cathode material for Li ion secondary batteries, which is provided with a dense layer of a conductive polymer on surfaces of primary particles of a cathode active material, the layer being excellent in the electron conductivity and Li ion conductivity, being able to suppress side reactions such as the oxidative decomposition of the electrolyte solution and the elution of the transition metal component in the cathode active material into the electrolyte solution, at the time of application of a high voltage during charging, and an efficient producing method thereof.

### SUMMARY OF THE INVENTION

### Means for Solving the Problem

A cathode material for secondary batteries according to a first aspect of the present invention is characterized in that surfaces of primary particles of an electrode active material base containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g, are coated with a layer containing a conductive polymer and a negative ion that enables the conductive polymer to produce electron conductivity equal to or higher than the electron conductivity of the electrode active material itself.

Here, “having a reversible charge/discharge capacity accompanying the electrode oxidation/reduction in the potential range described above of 30 mAh or more per 1 g” means to be 30 mAh or more per 1 g of the electrode active material base. Further, the “layer” is preferable to be “dense”. Here, being “dense” does not necessarily mean to be “free from defect” but means a state that can substantially prevent a direct contact between the electrode active material and the electrolyte solution when the conductive polymer layer (about 10% by mass or less in the cathode material) is disposed on particles of the electrode active material at an amount reasonable for not remarkably decreasing the volume energy density of the cathode material of the present aspect. Incidentally, the “surfaces of primary particles” being “coated” with the “layer” means a state where the “surfaces of primary particles” and the “layer” are integrated such as a state where the “layer” is precipitated on the “surfaces of primary particles”, for example, and does not include a state where the electrode active material base and the conductive polymer having the negative ion are simply mixed.

According to the present aspect, the surfaces of primary particles of the electrode active material base containing lithium, which has a relatively high redox potential where an oxidative decomposition of an electrolyte solution becomes a problem, are coated with a layer that contains the conductive polymer and a dopant negative ion that develops the conductivity. The relevant layer imparts the electron conductivity and Li ion conductivity and has a function as a protective layer that suppresses side reactions such as the oxidative decomposition of the electrolyte solution or the elution of a transition metal component in the cathode material into the electrolyte solution, when a high-voltage is applied during charging. Therefore, the electron conductivity and ion conductivity are excellent, and decomposition of the electrolyte solution and the elution of the transition metal component in the electrode active material into the electrolyte solution can be suppressed when a high-voltage is applied during charging.

A cathode material for secondary batteries according to a second aspect of the present invention is characterized in that in the first aspect, the electrode active material base is capable of the electrode oxidation/reduction accompanied by desorption and absorption of Li ions in the potential range of 4.3 V or more and 5 V or less based on a metal Li negative electrode and has a reversible charge/discharge capacity accompanying the electrode oxidation/reduction in the potential range described above of 30 mAh or more per 1 g.

According to the present aspect, the decomposition of the electrolyte solution and the elution of the transition metal component in the electrode active material into the electrolyte solution, at the time of application of a high voltage during charging described above can be suppressed also in the electrode active material containing lithium, which has a very high redox potential where the oxidative decomposition of the electrolyte solution or the like becomes a very large problem.

A cathode material for secondary batteries according to a third aspect of the present invention is characterized in that, in the first or second aspect, the conductive polymer is at least one of polyaniline, polypyrrole, and polythiophene.

According to the present aspect, the conductive polymer described above is at least one of polyaniline, polypyrrole, and polythiophene. These can be readily synthesized from aniline, pyrrole and thiophene, which are inexpensive and universal organic solvents, by chemical oxidative polymerization or electrochemical oxidative polymerization. Further, these conductive polymers exhibit P-type semiconductivity in which a positive hole is made a carrier due to doping of a negative ion described below in an oxidation state in the potential range of 4 V or more and 5 V or less based on the metal Li negative electrode, and all of these can develop high conductivity of about 10 S/cm or more. At the same time, the electron conductivity and Li ion conductivity can be preferably imparted because the negative ions take part in formation of a migrating path of the Li ions. Therefore, the excellent layer described above can be formed.

A cathode material for secondary batteries according to a fourth aspect of the present invention is characterized in that, in any one of the first to third aspects, the negative ion is at least one of BF₄⁻ and PF₆⁻.

The BF₄⁻ and PF₆⁻ are generally used as an electrolyte negative ion for lithium ion batteries. Since these are negative ions having a large ion radius, in which a plurality of fluorine atoms that are the strongest in the electronegativity are bound, a Li salt thereof is very easily ionized, and movement of the Li ions is excellently promoted when these are present in a layer of the conductive polymer. Further, these are high in the oxidation resistance, and are difficult to be oxidized and decomposed at the time of the electrode oxidation of a cathode active material having a particularly high redox potential such as LiNi_{0.5}Mn_{1.5}O₄. Further, these negative ions themselves are difficult to move in the layer. Still further, these are not dissociated from the interior of the layer, generate positive holes on a π conjugated chain of the conductive polymer, and electrostatically stabilize these. Therefore, these are high in the doping effect of improving the electron conductivity of the conductive polymer.

From these, a coating layer of the conductive polymer in which at least one of BF₄⁻ and PF₆⁻ is doped combines high conductivity and high ion conductivity, is difficult to be dissociated from the interior of the layer of the conductive polymer and is stably incorporated in the layer. The layer can be made such that it is excellent in the electron conductivity and ion conductivity and performs a function as a protective layer.

A cathode material for secondary batteries according to a fifth aspect of the present invention is characterized in that, in any one of the first to fourth aspects, the electrode active material base containing Li is at least one of a metal phosphate having an olivine crystal structure, a metal oxide having a spinel crystal structure and a metal oxide having a layered crystal structure.

According to the present aspect, the electrode active material base having Li is at least one of the metal phosphate having an olivine crystal structure, the metal oxide having a spinel crystal structure and the metal oxide having a layered crystal structure.

In these electrode active materials, when surfaces of primary particles of the electrode active material are coated with a layer that contains the conductive polymer and a negative ion as a dopant, the layer brings the effects such that the electron conductivity and Li ion conductivity are preferably imparted, and that the side reactions such as the oxidative decomposition of the electrolyte solution and the elution of the transition metal component in the cathode material into the electrolyte solution can be preferably suppressed at the time of application of a high voltage during charging.

A cathode material for secondary batteries according to a sixth aspect of the present invention is characterized in that, in the fifth aspect, the metal phosphate having an olivine crystal structure is represented by a formula LiMPO₄ (here, M represents at least one of Mn and Co, or a combination of at least one of Mn and Co and at least one of Fe and Ni).

According to the present aspect, when the surfaces of primary particles of the electrode active material are coated with the layer that contains a conductive polymer and a negative ion as a dopant, the layer brings the effects such that the electron conductivity and Li ion conductivity are preferably imparted, and that the side reactions such as the oxidative decomposition of the electrolyte solution and the elution of the transition metal component in the cathode material into the electrolyte solution at the time of application of a high voltage during charging can be preferably suppressed.

A cathode material for secondary batteries according to a seventh aspect of the present invention is characterized in that, in the fifth aspect, the metal phosphate having an olivine crystal structure is represented by a formula LiFeᵤMnᵥCo₁₋ᵤ₋ᵥPO₄ (here, u represents a number of 0 or more and 0.5 or less, v represents a number of 0 or more and 1 or less, and u+v is 1 or less).

According to the present aspect, when the surfaces of primary particles of the electrode active material are coated with the layer that contains a conductive polymer and a negative ion as a dopant, due to the layer, effects such that the electron conductivity and Li ion conductivity are preferably imparted, and the side reactions such as the oxidative decomposition of the electrolyte solution and the elution of the transition metal component in the cathode material into the electrolyte solution at the time of application of a high voltage during charging can be preferably suppressed can be preferably received.

A cathode material for secondary batteries according to an eighth aspect of the present invention is characterized in that, in the fifth aspect, the metal oxide having a spinel crystal structure is represented by a formula LiNiₜM′ₓMn₂₋ₜ₋ₓO₄ (here, M′ represents at least one of Fe, Co, Cr and Ti, t represents a number of 0 or more and 0.6 or less, x represents a number of 0 or more and 0.6 or less, and t+x is 0.8 or less).

According to the present aspect, when the surfaces of primary particles of the electrode active material are coated with the layer that contains the conductive polymer and the negative ion as a dopant, the layer brings the effects such that the electron conductivity and Li ion conductivity are preferably imparted, and that the side reactions such as the oxidative decomposition of the electrolyte solution and the elution of the transition metal component in the cathode material into the electrolyte solution at the time of application of a high voltage during charging can be preferably suppressed.

A cathode material for secondary batteries according to a ninth aspect of the present invention is characterized in that, in the fifth aspect, the metal oxide having a spinel crystal structure is represented by a formula LiNi_{0.5}Mn_{1.5}O₄.

According to the present aspect, when the surfaces of primary particles of the electrode active material are coated with the layer that contains a conductive polymer and a negative ion as a dopant, the layer brings the effects such that the electron conductivity and Li ion conductivity are preferably imparted, and that the side reactions such as the oxidative decomposition of the electrolyte solution and the elution of the transition metal component in the cathode material into the electrolyte solution can be preferably suppressed at the time of application of a high voltage during charging.

A cathode material for secondary batteries according to a tenth aspect of the present invention is characterized in that, in the fifth aspect, the metal oxide having a layered crystal structure is represented by a formula LiM″O₂ (here, M″ is at least one of Mn, Co and Ni, or a combination of at least one of Mn, Co and Ni and Al).

According to the present aspect, when the surfaces of primary particles of the electrode active material are coated with the layer that contains a conductive polymer and a negative ion as a dopant, the layer brings the effects such that the electron conductivity and Li ion conductivity are preferably imparted, and that the side reactions such as the oxidative decomposition of the electrolyte solution and the elution of the transition metal component in the cathode material into the electrolyte solution at the time of application of a high voltage during charging can be preferably suppressed.

A cathode material for secondary batteries according to an eleventh aspect of the present invention is characterized in that the surfaces of primary particles of an electrode active material base containing Li, which is capable of the electrode oxidation/reduction accompanied by desorption and absorption of Li ions in a potential range of 4 V or more and 5 V or less based on a metal Li negative electrode and has a reversible charge/discharge capacity of 30 mAh or more per 1 g accompanying the electrode oxidation/reduction in the potential range described above are coated with a layer containing a conductive polymer.

According to the present aspect, when a negative ion that enables the conductive polymer to produce electron conductivity equal to or higher than the electron conductivity of the electrode active material itself is contained in the layer containing the conductive polymer, the same effect as that of the first aspect can be obtained.

A cathode material for secondary batteries according to a twelfth aspect of the present invention is characterized in that, in the eleventh aspect, the electrode active material base is capable of the electrode oxidation/reduction accompanied by desorption and absorption of Li ions in a potential range of 4.3 V or more and 5 V or less based on the metal Li negative electrode and has the reversible charge/discharge capacity accompanying the electrode oxidation/reduction in the potential range described above of 30 mAh or more per 1 g.

According to the present aspect, when the negative ion is contained in the layer that contains the conductive polymer, the same effect as that of the second aspect can be obtained.

A cathode material for secondary batteries according to a thirteenth aspect of the present invention is characterized in that, in the eleventh aspect or twelfth aspect, the conductive polymer is at least one of polyaniline, polypyrrole, and polythiophene.

According to the present aspect, when the negative ion is contained in the layer that contains the conductive polymer, the same effect as that of the third aspect can be obtained.

A cathode material for secondary batteries according to a fourteenth aspect of the present invention is characterized in that, in any one of the eleventh to thirteenth aspects, the electrode active material base containing Li is at least one of a metal phosphate having an olivine crystal structure, a metal oxide having a spinel crystal structure and a metal oxide having a layered crystal structure.

According to the present aspect, when the negative ion is contained in the layer that contains the conductive polymer, the same effect as that of the fifth aspect can be obtained.

A cathode material for secondary batteries according to a fifteenth aspect of the present invention is characterized in that, in the fourteenth aspect, the metal phosphate having an olivine crystal structure is represented by a formula LiMPO₄ (here, M represents at least one of Mn and Co, or a combination of at least one of Mn and Co and at least one of Fe and Ni).

According to the present aspect, when the negative ion is contained in the layer that contains the conductive polymer, the same effect as that of the sixth aspect can be obtained.

A cathode material for secondary batteries according to a sixteenth aspect of the present invention is characterized in that, in the fourteenth aspect, the metal phosphate having an olivine crystal structure is represented by a formula LiFeᵤMnᵥCo₁₋ᵤ₋ᵥPO₄ (here, u represents a number of 0 or more and 0.5 or less, v represents a number of 0 or more and 1 or less, and u+v is 1 or less).

According to the present aspect, when the negative ion is contained in the layer that contains the conductive polymer, the same effect as that of the seventh aspect can be obtained.

A cathode material for secondary batteries according to a seventeenth aspect of the present invention is characterized in that, in the fourteenth aspect, the metal oxide having a spinel crystal structure is represented by a formula LiNiₜM′ₓMn₂₋ₜ₋ₓO₄ (here, M′ represents at least one of Fe, Co, Cr and Ti, t represents a number of 0 or more and 0.6 or less, x represents a number of 0 or more and 0.6 or less, and t+x is 0.8 or less).

According to the present aspect, when the negative ion is contained in the layer that contains the conductive polymer, the same effect as that of the eighth aspect can be obtained.

A cathode material for secondary batteries according to an eighteenth aspect of the present invention is characterized in that, in the fourteenth aspect, the metal oxide having a spinel crystal structure is represented by a formula LiNi_{0.5}Mn_{1.5}O₄.

According to the present aspect, when the negative ion is contained in the layer that contains the conductive polymer, the same effect as that of the ninth aspect can be obtained.

A cathode material for secondary batteries according to a nineteenth aspect of the present invention is characterized in that, in the fourteenth aspect, the metal oxide having a layered crystal structure is represented by a formula LiM″O₂ (here, M″ represents at least one of Mn, Co and Ni, or a combination of at least one of Mn, Co and Ni and Al).

According to the present aspect, when the negative ion is contained in the layer that contains the conductive polymer, the same effect as that of the tenth aspect can be obtained.

A cathode material for secondary batteries according to a twentieth aspect of the present invention is characterized in that, in any one of the eleventh to nineteenth aspects, after the cathode material for secondary batteries is incorporated in a lithium secondary battery, in a process of charging the lithium secondary battery, a negative ion, which is a negative ion in an electrolyte of the lithium secondary battery and enables the conductive polymer to produce electron conductivity equal to or higher than the electron conductivity of the electrode active material itself, is doped in the conductive polymer.

According to the present aspect, when the negative ion is contained in the layer that contains the conductive polymer, the same effect as that of any one of the first aspect to tenth aspect can be obtained.

A method for producing a cathode material for secondary batteries according to a twenty-first aspect of the present invention is characterized by including the steps of: oxidizing a part of an electrode active material by bringing a solution in which an oxidant that has oxidation power capable of at least partially oxidizing the electrode active material and capable of oxidizing and polymerizing a monomer or an oligomer to be a raw material of a conductive polymer is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and thereafter, coating surfaces of primary particles of the electrode active material with a layer that contains the conductive polymer and a negative ion by oxidizing and polymerizing the monomer or oligomer while doping the negative ion by bringing a solution in which the monomer or oligomer and the negative ion are dissolved into contact with the entire surface of the electrode active material.

According to the present aspect, a cathode material for secondary batteries, which is excellent in the electron conductivity and Li ion conductivity and can suppress decomposition of an electrolyte solution and elution of the transition metal component in the electrode active material into the electrolyte solution at the time of application of a high voltage during charging, can be produced.

Incidentally, “a solution in which the monomer or oligomer, and negative ion are dissolved” is preferable to be a solution in which also Li ions are dissolved.

A method for producing a cathode material for secondary batteries according to a twenty-second aspect of the present invention is characterized by including the steps of: allowing an entire surface of an electrode active material to adsorb a monomer or oligomer by bringing a solution in which the monomer or oligomer to be a raw material of a conductive polymer is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and, thereafter, coating surfaces of primary particles of the electrode active material with a layer containing the conductive polymer and a negative ion by oxidizing and polymerizing the monomer or oligomer while doping the negative ion by bringing a solution in which an oxidant having oxidizing power capable of oxidizing and polymerizing the monomer or oligomer and the negative ion that enables the conductive polymer to produce electron conductivity equal to or higher than the electron conductivity of the electrode active material itself are dissolved into contact with the entire surface of the electrode active material.

According to the present aspect, a cathode material for secondary batteries, which is excellent in the electron conductivity and Li ion conductivity and can suppress the decomposition of an electrolyte solution and the elution of the transition metal component in the electrode active material into the electrolyte solution at the time of application of a high voltage during charging, can be produced.

Incidentally, “a solution in which an oxidant having oxidation power capable of oxidizing and polymerizing the monomer or oligomer and a negative ion that enables the conductive polymer to produce electron conductivity equal to or higher than the electron conductivity of the electrode active material itself are dissolved” is preferably a solution in which also Li ions are dissolved.

A method for producing a cathode material for secondary batteries according to a twenty-third aspect of the present invention is characterized by including the steps of: oxidizing a part of an electrode active material by bringing an oxidant that has oxidation power capable of at least partially oxidizing the electrode active material and capable of oxidizing and polymerizing a monomer or an oligomer to be a raw material of a conductive polymer or a solution in which the oxidant is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and thereafter, coating surfaces of primary particles of the electrode active material with a layer that contains a conductive polymer by oxidizing and polymerizing the monomer or oligomer by bringing a solution in which any one of the monomer or oligomer, or the monomer and oligomer are dissolved into contact with the entire surface of the electrode active material.

According to the present aspect, when the negative ion is contained in the layer that contains the conductive polymer, the same effect as that of the twenty-first aspect can be obtained.

A method for producing a cathode material for secondary batteries according to a twenty-fourth aspect of the present invention is characterized by including the steps of: allowing an entire surface of an electrode active material to adsorb the monomer or oligomer, by bringing a solution in which any one of the monomer or oligomer, or the monomer and oligomer, which are a raw material of a conductive polymer is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and, thereafter, coating surfaces of primary particles of the electrode active material with a layer containing a conductive polymer by oxidizing and polymerizing the monomer or oligomer by bringing a solution in which an oxidant having oxidizing power capable of oxidizing and polymerizing the monomer or oligomer into contact with the entire surface of the electrode active material.

According to the present aspect, when the negative ion is contained in the layer that contains the conductive polymer, the same effect as that of the twenty-second aspect can be obtained.

A method for producing a cathode material for secondary batteries according to a twenty-fifth aspect of the present invention is characterized by including the step of: in the twenty-third or twenty-fourth aspect, coating surfaces of primary particles of the electrode active material with a layer containing the conductive polymer and negative ions by oxidizing and polymerizing the monomer or oligomer while doping the negative ions by making the negative ion that enables the conductive polymer to produce electron conductivity equal to or higher than the electron conductivity of the electrode active material itself coexist on an entire surface of the electrode active material when the monomer or oligomer is oxidized and polymerized.

According to the present aspect, a cathode material for secondary batteries, which is excellent in the electron conductivity and Li ion conductivity and can suppress decomposition of the electrolyte solution and the elution of the transition metal component in the electrode active material into the electrolyte solution at the time of application of a high voltage during charging, can be produced.

A method for producing a cathode material for secondary batteries according to a twenty-sixth aspect of the present invention is characterized by including the step of: in the twenty-third or twenty-fourth aspect, doping the negative ion in the conductive polymer, in which the negative ion that is a negative ion in an electrolyte of the lithium secondary battery and enables the conductive polymer to produce electron conductivity equal to or higher than the electron conductivity of the electrode active material itself in a charging process of the lithium secondary battery, after the cathode material for secondary batteries is incorporated in the lithium secondary battery.

According to the present aspect, a cathode material for secondary batteries, which is excellent in the electron conductivity and Li ion conductivity and can suppress decomposition of the electrolyte solution and the elution of the transition metal component in the electrode active material into the electrolyte solution at the time of application of a high voltage during charging, can be produced.

A secondary battery according to a twenty-seventh aspect of the present invention is characterized by including the cathode material for secondary batteries according to any one of the first to twentieth aspects, or the cathode material for secondary batteries produced by the producing method according to any one of the twenty-first to twenty-sixth aspects, as one of constituent members.

According to the present aspect, a secondary battery, which is excellent in the electron conductivity and Li ion conductivity and can suppress the decomposition of the electrolyte solution and the elution of the transition metal component in the electrode active material into the electrolyte solution, at the time of application of a high voltage during charging, can be produced.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a diagram that shows cycle characteristics evaluation of coin batteries of Example 1 and Comparative Example 1.

FIG. 2 is a diagram that shows cycle characteristics evaluation of coin batteries of Example 1 and Comparative Example 1.

FIG. 3 is a diagram that shows cycle characteristics evaluation of coin batteries of Example 2 and Comparative Example 2.

FIG. 4 is a diagram that shows cycle characteristics evaluation of coin batteries of Example 2 and Comparative Example 2.

### DETAILED DESCRIPTION OF THE INVENTION

A cathode material for secondary batteries according to a present invention is characterized in that surfaces of primary particles of an electrode active material base containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g are coated with a layer containing a conductive polymer and a negative ion that enables the conductive polymer to produce electron conductivity equal to or higher than the electron conductivity of the electrode active material itself.

Here, “having a reversible charge/discharge capacity accompanying the electrode oxidation/reduction in the potential range described above of 30 mAh or more per 1 g” means to be 30 mAh or more per 1 g of the electrode active material base. Further, the “layer” is preferable to be dense. Here, “being dense” does not necessarily means to be “free from defect” but means a state that substantially prevents a direct contact between the electrode active material and the electrolyte solution when the conductive polymer layer of an amount reasonable for not remarkably decreasing the volume energy density of the cathode material (about 10% by mass or less in the cathode material) of the present aspect is disposed on the particles of the electrode active material. Incidentally, the “surfaces of primary particles” being “coated” with the “layer” means a state where the “surfaces of primary particles” and the “layer” are integrated such as a state where the “layer” is precipitated on the “surfaces of primary particles”, for example, and does not contain a state where the electrode active material base and the conductive polymer having the negative ion are simply mixed.

A layer that contains the conductive polymer and a dopant negative ion (a negative ion that enables the conductive polymer to produce electron conductivity equal to or higher than the electron conductivity of the electrode active material itself) that develops conductivity imparts the electron conductivity and Li ion conductivity and functions as a protective layer that suppresses side reactions such as the oxidative decomposition of the electrolyte solution and the elution of the transition metal component in the cathode material into the electrolyte solution, when a high-voltage is applied during charging. Therefore, the cathode material for secondary batteries of the present invention is excellent in the electron conductivity and Li ion conductivity and can suppress the decomposition of the electrolyte solution and the elution of the transition metal component in the electrode active material into the electrolyte solution, when a high-voltage is applied during charging.

Further, a case where an electrode active material of which reversible charge/discharge capacity accompanying the electrode oxidation/reduction in the potential range of 4 V or more and 5 V or less based on a metal Li negative electrode does not satisfy 30 mAh per 1 g is used is out of the scope of the cathode material for secondary batteries of the present invention. Among such cases, regarding the cathode active material of a relatively low voltage such as having the reversible charge/discharge capacity in a redox potential range of less than 4 V based on a metal Li negative electrode, also in the case of not having the aspect described above, the side reactions such as the oxidative decomposition of the electrolyte solution and the elution of the transition metal in the cathode material into the electrolyte solution may not be necessarily practically problematic.

On the contrary, regarding the cathode active material of very high voltage such as having the reversible charge/discharge capacity in a redox potential range exceeding 5 V based on the metal Li negative electrode, the conductive polymer itself tends to be degraded by strong oxidation by the cathode active material, therefore, also when the present aspect is being possessed, there is a fear that side reactions such as the oxidative decomposition of the electrolyte solution and the elution of the transition metal component in the cathode material into the electrolyte solution may not be prevented.

Further, the electrode active material base is preferably capable of the electrode oxidation/reduction accompanied by desorption and absorption of Li ions in a potential range of 4.3 V or more and 5 V or less based on the metal Li negative electrode and to have the reversible charge/discharge capacity accompanying the electrode oxidation/reduction in the potential range described above of 30 mAh or more per 1 g.

This is because the decomposition of the electrolyte solution and the elution of the transition metal component in the electrode active material into the electrolyte solution, when a high-voltage is applied during charging, which were described above, can be suppressed also in the electrode active material containing lithium, which has a very high redox potential where the oxidative decomposition of the electrolyte solution becomes a very large problem.

The conductive polymer in the cathode material for secondary batteries of the present invention is preferably at least one of polyaniline, polypyrrole and polythiophene.

These can be readily synthesized from aniline, pyrrole and thiophene, which are cheap and universal organic solvents, by chemical oxidative polymerization or electrochemical oxidative polymerization. Further, these conductive polymers exhibit P-type semiconductivity in which a positive hole is made a carrier by doping a negative ion, which is described below, in an oxidation state in the potential range of 4 V or more and 5 V or less based on the metal Li negative electrode, and all of these can develop high conductivity of about 10 S/cm or more. At the same time, the electron conductivity and ion conductivity can be preferably imparted because the negative ions described above form a traveling path of the Li ions. Therefore, the excellent layer can be formed.

In addition, as conductive polymers that can be used in the present invention, for example, the followings can be used. Behaviors and characteristics of these are substantially similar to the behaviors and the characteristics of the above-described polyaniline, polypyrrole, and polythiophene, which have a polymer main chain of a π conjugated double bond provided with aromaticity.

[Examples of unsubstituted conductive polymers (other than polyaniline, polypyrrole and polythiophene)]

Poly (p-phenylene), poly (p-phenylene vinylene), polyfluorene, polyazulene, poly diphenyl benzidine, polyvinyl carbazole, poly (p-thienylene vinylene), and poly (triphenylamine) and the like.

[Examples of conductive polymers with substituent] Examples include substituted conductive polymers obtained by substituting a hydrogen atom of at least one methylene group that constitutes a conjugated ring portion in a molecular structure of each of the respective unsubstituted conductive polymers with a substituent such as an alkyl group, an alkoxy group, a fluorinated alkyl group, and a fluorinated alkoxy group. Specific examples include poly (3-methylaniline), poly (N-methyl aniline), poly (3-trifluoromethyl aniline), poly (3,4-ethylenedioxythiophene) and the like.

Here, each substituent influences on a generation state of positive holes of an aromatic ring of a main chain, changes the electron conductivity, and influences on a form/property of a layer of the conductive polymer. Further, when a thiol group (mercapto group) or the like having adhesiveness to other substances is contained in the substituent, bonding to the cathode active material may be enhanced.

Among the conductive polymers illustrated above, at least one thereof can be used singularly or in a combination.

The negative ion in the cathode material for secondary batteries of the present invention is preferably any one of BF₄⁻ and PF₆⁻.

BF₄⁻ and PF₆⁻ are generally used as an electrolyte negative ion for lithium ion batteries. Since these are negative ions that are formed by bonding a plurality of fluorine atoms that are an element the strongest in the electronegativity and have a large ionic radius, Li salts thereof are very easily ionized, and, when present in a layer of a conductive polymer, greatly promote the movement of Li ions. Further, these negative ions are high in the oxidation resistance and difficult to be oxidized and decomposed also in the case of electrode oxidation of a cathode active material having a particularly high redox potential such as LiNi_{0.5}Mn_{1.5}O₄ for example. Further, these negative ions themselves are difficult to move in the layer. Still further, a doping effect that improves the electron conductivity of the conductive polymer is high because these negative ions do not dissociate from the interior of the layer, generate positive holes on a π conjugated chain of the conductive polymer, and statically stabilize these.

From these, a coating layer of the conductive polymer doped with at least one of BF₄⁻ and PF₆⁻ exerts high conductivity and high Li ion conductivity; these negative ions are unlikely to be dissociated from the interior of the layer of the conductive polymer and stably incorporated in the layer. The layer can be made a layer that is excellent in the electron conductivity and ion conductivity and combines a role as the protective layer.

In addition to the BF₄⁻ and PF₆⁻, also the following negative ions can be used as the negative ion. All of these have similar characteristics as the characteristics of the BF₄⁻ and PF₆⁻ and function as an electrolyte anion of the electrolyte solution and a dopant negative ion of the conductive polymer of a lithium ion battery.

Examples of these include AsF₆⁻, CF₃SO₃⁻, [N(C₁F₂₁₋₁SO₂) (CF₂ₘ₊₁SO₂)] (here, 1, m each is a positive integer), [C(CₚF₂ₚ₊₁SO₂) (CᵣF₂ᵣ₊₁SO₂) (CᵣF₂ᵣ₊₁SO₂)] (here, p, q, r each is a positive integer), a bis(oxalate)borate ion, a tris(oxalate)phosphate ion, a difluoro(oxalate)borate ion, a difluorobis(oxalate)phosphate ion and the like.

Among the dopant negative ions illustrated above, at least one thereof can be used singularly or in a combination. Further, all of these negative ions can be preferably used as an electrolyte for secondary batteries described below in the form of a salt with Li ion.

Further, other than these, also a benzene sulfonate ion, an alkyl benzene sulfonate ion, a polystyrene sulfonate ion (PSS) and the like, and a monomer, oligomer or polymer of aromatic sulfonate ion can be used. In particular, when the polystyrene sulfonate ion (PSS) that is a polymer is used, the polystyrene sulfonate ion (PSS⁻) can be used also as a copolymer with any one of the above-described conductive polymers or in a combination of a plurality of these conductive polymers.

As described above, the electrode active material base containing Li in the cathode material for secondary batteries of the present invention is capable of the electrode oxidation/reduction accompanied by desorption and absorption of Li ions in the potential range of 4 V or more and 5 V or less based on the metal Li negative electrode and has the reversible charge/discharge capacity accompanying the electrode oxidation/reduction in the potential range described above of 30 mAh or more per 1 g. In the potential range of 4.3 V or more and 5 V or less based on the metal Li negative electrode, it is preferable that the electrode oxidation/reduction accompanied by desorption and absorption of Li ions is possible and the reversible charge/discharge capacity accompanying the electrode oxidation/reduction in the potential range described above is 30 mAh or more per 1g. As a specific example of the electrode active material base containing Li, at least one of metal phosphates having an olivine crystal structure, metal oxides having a spinel crystal structure and metal oxides having a layered crystal structure can be cited and used preferably.

These specifically cited electrode active materials are capable of obtaining, due to adjustment of element composition, properties where the electrode oxidation/reduction accompanied by desorption and absorption of Li ions in the potential range of 4 V or more and 5 V or less based on the metal Li negative electrode is possible and the reversible charge/discharge capacity accompanying the electrode oxidation/reduction in the potential range described above becomes mAh per 1 g. When the reversibly chargeable/dischargeable capacity is effectively utilized, the electrode active material like this is necessary to be charged and oxidized at a high upper limit potential up to about 4.3 to 5 V based on the metal Li negative electrode.

At this time, when the surfaces of primary particles of the relevant electrode active material are coated with a layer that contains the conductive polymer and the negative ion as the dopant, an effect that the layer preferably imparts the electron conductivity and Li ion conductivity and can preferably suppress the side reactions such as the oxidative decomposition of the electrolyte solution and the elution of the transition metal component in the cathode material into the electrolyte solution, at the time of application of a high voltage during charging can be preferably received.

As the metal phosphates having an olivine crystal structure, for example, ones represented by a formula LiMPO₄ (here, M represents at least one of Mn and Co, or a combination of at least one of Mn and Co and at least one of Fe and Ni) and ones represented by a formula LiFeᵤMnᵥCo₁₋ᵤ₋ᵥPO₄ (here, u represents a number of 0 or more and 0.5 or less, v represents a number of 0 or more and 1 or less, and u +v is 1 or less) can be preferably used. Hereinafter, these will be described.

In the metal phosphate of a formula LiMPO₄ having an olivine crystal structure, when, with one of M=Mn having the redox potential in the vicinity of about 4.1 V based on the metal Li negative electrode as a main body, a single phase thereof or a solid solution phase in which an element composition is adjusted is used as the electrode active material, characteristics such that the electrode oxidation/reduction accompanied by desorption and absorption of Li ions is possible in the potential range of 4 V or more and less than 4.5 V based on the metal Li negative electrode and the reversible charge/discharge capacity accompanying the electrode oxidation/reduction in the potential range described above becomes 30 mAh or more per 1 g can be obtained.

In order to effectively utilize the reversibly chargeable/dischargeable capacity, such electrode active materials are necessarily charged and oxidized at a relatively high upper limit potential up to about 4.3 to 4.5 V based on the metal Li negative electrode. At this time, when surfaces of primary particles of the electrode active material are coated with a layer that contains the conductive polymer and the negative ion as a dopant, effects such that the layer preferably imparts the electron conductivity and Li ion conductivity, and preferably suppresses the side reactions such as the oxidative decomposition of the electrolyte solution and the elution of the transition metal component in the cathode material into the electrolyte solution, at the time of application of a high voltage during charging can be preferably received.

Further, in the metal phosphate of a formula LiMPO₄ having an olivine crystal structure, when, with one of M=Co having the redox potential in the vicinity of about 4.8 V as a main body, a single phase thereof or a solid solution phase in which an element composition is adjusted is used as the electrode active material, characteristics where the electrode oxidation/reduction accompanied by desorption and absorption of Li ions in the potential range of 4.5 V or more and 5 V or less based on the metal Li negative electrode is possible and the reversible charge/discharge capacity accompanying the electrode oxidation/reduction in the potential range described above becomes 30 mAh or more per 1 g can be obtained.

In order to effectively utilize the reversibly chargeable/dischargeable capacity, such electrode active materials are necessarily charged and oxidized at a very high upper limit potential such as about 5V based on the metal Li negative electrode.

At this time, when surfaces of primary particles of the electrode active material are coated with a layer that contains the conductive polymer and the negative ion as a dopant, effects such that the layer preferably imparts the electron conductivity and Li ion conductivity and can preferably suppress the side reactions such as the oxidative decomposition of the electrolyte solution and the elution of the transition metal component in the cathode material into the electrolyte solution at the time of application of a high voltage during charging, can be particularly preferably received.

Incidentally, the metal phosphate of a formula LiMPo₄ having an olivine crystal structure has a tendency to be thermomechanically unstable in its electronic state, in the case of M=Mn, in a redox state of trivalent Mn, further, in the case of M=Co, in a redox state of divalent Mn. As a result of generation of strain in the crystal structure to resolve the tendency (Jahn-Teller effect), the crystal structure of the electrode active material becomes unstable, and the charge/discharge characteristics tend to be degraded. At this time, when a solid solution phase in which at least one of M=Fe and M=Ni, which are free from such fear is combined with a phase mainly made of at least one of M=Mn and M=Co is used as the electrode active material, the crystal structure can be stabilized and the charge/discharge characteristics can be prevented from degrading in any one of charge/discharge state.

Here, among the metal phosphates of a formula LiMPO₄ having an olivine crystal structure, one of M=Ni is too high such as about 5.1 V in the redox potential, therefore in any state of single layer/solid solution phase, a capacity of contained Ni cannot be practically utilized. On the other hand, since one of M=Fe having the redox potential of about 3.4 V can utilize the reversible charge/discharge capacity of contained Fe in the potential range of 3 to 4 V in any state of single layer/solid solution phase, it is advantageous to dissolve Fe rather than Ni to stabilize the electrode active material. However, when Fe is dissolved at too high proportion, the reversible charge/discharge capacity in the redox potential range of 4 V or more decreases. By considering these, one represented by a formula LiFeᵤMnᵥCo₁₋ᵤ₋ᵥPO₄ (here, u represents a number of 0 or more and 0.5 or less, v represents a number of 0 or more and 1 or less, and u+v is 1 or less) becomes an electrode active material particularly suitable for the object of the present invention.

Further, as the metal oxide having a spinel crystal structure, for example, ones represented by a formula LiNiₜM′ₓMn₂₋ₜ₋ₓO₄ (here, M′ represents at least one of Fe, Co, Cr and Ti, t represents a number of 0 or more and 0.6 or less, x represents a number of 0 or more and 0.6 or less, and t +x is 0.8 or less), and one represented by a formula LiNi_{0.5}Mn_{1.5}O₄ can be preferably used. Hereinafter, these will be described.

The Li-containing metal oxide having a spinel crystal structure can obtain, by adjusting an element composition thereof, characteristics such that the electrode oxidation/reduction accompanied by desorption and absorption of Li ions in the potential range of 4 V or more and 5 V or less based on the metal Li negative electrode is possible and the reversible charge/discharge capacity accompanying the electrode oxidation/reduction in the potential range described above becomes 30 mAh or more per 1 g. In order to effectively utilize the reversibly chargeable/dischargeable capacity, such electrode active materials are necessarily charged and oxidized at a high upper limit potential up to about 4.3 to 5V based on the metal Li negative electrode.

At this time, when surfaces of primary particles of the electrode active material are coated with a layer that contains the conductive polymer and the negative ion as a dopant, effects such that the layer preferably imparts the electron conductivity and Li ion conductivity and can preferably suppress the side reactions such as the oxidative decomposition of the electrolyte solution and the elution of the transition metal component in the cathode material into the electrolyte solution, at the time of application of a high voltage during charging, can be preferably received.

In particular, one represented by a formula LiNi_{0.5}Mn_{1.5}O₄, or ones having a composition close to this, and ones in which a part of Ni and/or Mn of these is substituted with at least one of Fe, Co, Cr and Ti have the redox potential in the vicinity of about 4.7 V based on the metal Li negative electrode and can obtain characteristics such that the electrode oxidation/reduction accompanied by desorption and absorption of Li ions in the potential range of 4.5 V or more and 5 V or less based on the metal Li negative electrode is possible and the reversible charge/discharge capacity accompanying the electrode oxidation/reduction in the potential range described above becomes 30 mAh or more per 1 g.

In order to effectively utilize the reversibly chargeable/dischargeable capacity, such electrode active materials are necessarily charged and oxidized at a very high upper limit potential such as about 5V based on the metal Li negative electrode.

At this time, when surfaces of primary particles of the electrode active material are coated with a layer that contains the conductive polymer and the negative ion as a dopant, effects such that the layer preferably imparts the electron conductivity and Li ion conductivity and can preferably suppress the side reactions such as the oxidative decomposition of the electrolyte solution and the elution of the transition metal component in the cathode material into the electrolyte solution, at the time of application of a high voltage during charging, can be particularly preferably obtained.

Incidentally, in the above, one obtained by partially substituting Ni and/or Mn with at least one of Fe, Co, Cr and Ti may be improved in the stability of the crystal structure than one obtained by without substituting.

Further, one represented by a formula LiNi_{0.5}Mn_{1.5}O₄, or ones having a composition close to this, and ones in which a part of Ni and/or Mn of these is substituted with at least one of Fe, Co, Cr and Ti are generally synthesized by a solid phase sintering of raw materials in an atmosphere under presence of oxygen such as air. When the relevant electrode active material is heated at a temperature exceeding 700° C. in an environment of low oxygen partial pressure, oxygen atoms in the crystal of electrode active material are dissociated and become deficient, and the reversible charge/discharge capacity in a redox range of about 4.7 V is decreased. Therefore, to the electrode active material like this, a conductivity-imparting process such as carbon coating due to thermal decomposition of a carbon precursor, which necessitates heating at about 700° C. or more in an inert gas atmosphere, cannot be performed. By contrast, a thin layer coating of the conductive polymer containing the negative ion of the present invention has an advantage such that both the electron conductivity and the Li ion conductivity can be imparted irrespective of the producing method of the active material base.

Further, as the metal oxide having a layered crystal structure, for example, ones represented by a formula LiM″O₂ (here, M″ represents at least one of Mn, Co and Ni, or a combination of at least one of Mn, Co and Ni and Al) can be preferably used.

Among ones represented by a formula LiM″O₂ having the layered crystal structure (here, M″ represents at least one of Mn, Co and Ni, or a combination of at least one of Mn, Co and Ni and Al), a part thereof are electrode active materials commercially available at the present time, and almost all thereof have characteristics such that the electrode oxidation/reduction accompanied by desorption and absorption of Li ions in the potential range of 4 V or more and less than 4.5 V based on the metal Li negative electrode is possible and the reversible charge/discharge capacity accompanying the electrode oxidation/reduction in the potential range described above becomes 30 mAh or more per 1 g.

In order to effectively utilize the reversibly chargeable/dischargeable capacity, such electrode active materials are necessarily charged and oxidized at a relatively high upper limit potential up to about 4.3 to 4.5 V based on the metal Li negative electrode. At this time, when surfaces of primary particles of the electrode active material are coated with a layer that contains the conductive polymer and the negative ion as a dopant, effects such that the layer preferably imparts the electron conductivity and Li ion conductivity and can preferably suppress the side reactions such as the oxidative decomposition of the electrolyte solution and the elution of the transition metal component in the cathode material into the electrolyte solution, at the time of application of a high voltage during charging, can be preferably received.

Further, ones represented by a formula LiMn″O₂ having the layered crystal structure are generally synthesized by a solid phase sintering of raw materials in an atmosphere under presence of oxygen such as air. When the relevant electrode active material is heated at a temperature exceeding 700° C. in an environment having low oxygen partial pressure, oxygen atoms in the crystal of electrode active material are dissociated and become deficient, and the reversible charge/discharge capacity is decreased. Therefore, to the electrode active material like this, a conductivity-imparting process such as carbon coating or the like due to thermal decomposition of a carbon precursor, which necessitates heating at about 700° C. or more in an inert gas atmosphere, cannot be performed. By contrast, a thin layer coating of the conductive polymer containing the negative ion of the present invention has an advantage such that both the electron conductivity and the Li ion conductivity can be imparted irrespective of the producing method of the active material base.

Further, secondary batteries containing the cathode materials for secondary batteries described above, or cathode active materials for secondary batteries produced according to producing methods such as the following examples as one of constituent members can be produced. Such secondary batteries are excellent in the electron conductivity and Li ion conductivity and can suppress decomposition of the electrolyte solution and the elution of the transition metal component in the electrode active material into the electrolyte solution, at the time of application of a high voltage during charging.

By using the cathode material for secondary batteries such as described above as a cathode, and by using a material that has a potential of 1.6 V or less based on the metal lithium electrode and can insert and dissociate lithium ions (for example, lithium titanate (Li₄Ti₅O₁₂) having a spinel crystal structure, graphite, amorphous carbon materials and the like) as a negative electrode, a nonaqueous electrolyte secondary battery having high capacity can be provided.

As a negative electrode active material in the negative electrode, ones that have been used in conventional lithium ion batteries can be applied, intercalating materials capable of absorbing an alkali metal such as lithium, for example, graphite particles, or carbonaceous materials having carbonaceous composite particles in which graphite particles are coated with a carbon layer can be used. Further, 1.5 V (vs Li/Li⁺) class electrode materials such as lithium titanate, and various intercalating materials that show an intercalation voltage of about 0 to 2 V relative to metal Li such as titanium oxide and niobium oxide can be used.

The electrode materials such as described above can be mounted according to various methods such as winding and laminating because these materials can be formed as a sheet electrode having high energy density and high strength. Although a form of the secondary battery is not particularly limited, the electrode material like this can be mounted on cylinder, coin, gum and flat secondary batteries.

As an electrolyte solution in the secondary battery, a non-aqueous electrolyte can be used, and as the non-aqueous electrolyte, one obtained by dissolving an electrolyte salt in a non-aqueous solvent can be used.

As the non-aqueous solvent, cyclic carbonate esters, linear carbonate esters, esters, cyclic ethers, linear ethers, nitriles, amides and combinations thereof can be used.

As the cyclic carbonate ester, ethylene carbonate, vinylene carbonate, propylene carbonate, butylene carbonate and the like can be used. Further, ones obtained by partially or entirely substituting hydrogen groups thereof with fluorine, such as trifluoropropylene carbonate, and fluoroethyl carbonate can be used.

As the linear carbonate ester, dimethyl carbonate, ethyl methyl carbonate, diethyl carbonate, methyl propyl carbonate, ethyl propyl carbonate, methyl isopropyl carbonate and the like can be used, and also ones obtained by substituting partially or entirely hydrogen groups thereof with fluorine can be used.

As the esters, methyl acetate, ethyl acetate, propyl acetate, methyl propionate, ethyl propionate, γ-butyrolactone and the like can be used.

As the cyclic ethers, 1,3-dioxolane, 4-methyl-1,3-dioxolane, tetrahydrofuran, 2-methyl tetrahydrofuran, propylene oxide, 1,2-butylene oxide, 1,4-dioxane, 1,3,5-trioxane, furan, 2-methylfuran, 1,8-cineole, crown ether and the like can be used, and also ones obtained by partially or entirely substituting hydrogen groups thereof with fluorine can be used.

As the linear ethers, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxy benzene, 1,2-diethoxy ethane, 1,2-dibutoxy ethane, diethylene glycol dimethyl ether, diethylene glycol diethyl ether, diethylene glycol dibutyl ether, 1,1-dimethoxy methane, 1,1-diethoxy ethane, triethylene glycol dimethyl ether, tetraethylene glycol dimethyl and the like can be used, and also ones obtained by substituting partially or entirely hydrogen groups thereof with fluorine can be used, for example, 2,2,3,3,3-pentafluoropropyl-1,1,2,2-tetrafluoroethyl ether can be used.

As the nitriles, acetonitrile and the like can be used, and as the amides, dimethyl formamide and the like can be used.

Among the nonaqueous solvents described above, particularly from the viewpoint of voltage stability, anyone of cyclic carbonate esters such as ethylene carbonate and propylene carbonate, and, linear carbonate esters such as dimethyl carbonate, diethyl carbonate and dipropyl carbonate can be preferably used. One kind thereof may be used or two or more kinds thereof may be combined. Further, from the viewpoint of the oxidation resistance and heat-resistant stability, which are particularly required at the time of high-voltage charging, it is preferable to use, at least partially, ones obtained by partially or entirely substituting hydrogen groups in the alkyl groups of the nonaqueous solvent molecule with fluorine.

Further, in these nonaqueous solvents, phosphate esters having high flame resistance such as trimethyl phosphate and triethyl phosphate, further, ones obtained by partially or entirely substituting hydrogen groups thereof with fluorine, for example, tris(2,2-trifluoroethyl)phosphate, can be added as a flame retardant.

In particular, when the cathode material of the present invention, that is, the cathode material that is made of the electrode active material that is covered with a layer containing the conductive polymer and the dopant negative ion that develops the conductivity is used together with an electrolyte solution high in the oxidation resistance and heat resistant stability, which contains the fluorinated nonaqueous solvent, phosphate esters and the like, side reactions such as the oxidative decomposition of the electrolyte solution and the elution of the transition metal component in the cathode material into the electrolyte solution may be more effectively suppressed.

As the electrolyte salt, LiPF₆, LiAsF₆, LiBF₄, LiCF₃SO₃, LiN(C₁F₂₁₊₁SO₂) (CₘF₂ₘ₊₁SO₂) (1 and m each is a positive integer), LiC(CₚF₂ₚ₊₁SO₂) (C_{q}F_{2q+1}SO₂) (CᵣF₂ᵣ₊₁SO₂) (p, q and r each is a positive integer), lithium bis(oxalato)borate, lithium tris(oxalato)phosphate, lithium difluoro(oxalato)borate, or lithium difluorobis(oxalato)phosphate and the like can be used. These may be used singularly or in a combination of two or more kinds thereof.

Further, as a separator that separates the cathode and the negative electrode, ones that are low in the resistance against ion migration in the electrolyte solution and excellent in the solution retention property are used, and nonwoven fabrics or woven fabrics made of one or more kinds of materials selected from, for example, glass, polyester, polytetrafluoroethylene, polyethylene, polyamide, aramid, polypropylene, and fluororubber-coated cellulose can be used.

In the secondary batteries according to the present invention, in place of the electrolyte solution such as described above, a solid electrolyte may be used as the electrolyte.

According to the solid electrolyte, a battery that is free from imbalanced distribution of the electrolyte solution and liquid leakage, is less in gas generation and is suppressed from deforming can be obtained.

As a material, for example, in an inorganic system, metal halides such as AgCl, AgBr, AgI and LiI, RbAg₄I₅, and RbAg₄I₄CN can be used. Further, in an organic system, composites obtained by dissolving the electrolyte salts described above in a polymer matrix such as polyethylene oxide, polypropylene oxide, polyfluorinated vinylidene, or polyacrylamide, or gel-crosslinking bodies thereof, polymer solid electrolytes obtained by grafting ion dissociation groups such as low molecular weight polyethylene oxide and crown ether to a polymer main chain, or gel-like polymer solid electrolytes obtained by incorporating the electrolyte solutions in the high molecular weight polymers can be used.

In particular, when the gel-like polymer solid electrolyte is used, a thin flat battery having higher reliability can be obtained.

### EXAMPLES

Hereinafter, the present invention will be described in detail with reference to examples.

However, the present invention is not restricted by these examples.

### Example 1

Hereinafter, a producing method of Example 1 will be described. At the beginning, a LiNi_{0.5}Mn_{1.5}O₄ base was prepared according to the following procedure.

Firstly, a reagent Li₂CO₃ (hereinafter, referred to as a Li source reagent), Ni(NO₃)₂.6H₂O (hereinafter, referred to as a Ni source reagent) and a reagent MnO₂ (hereinafter referred to as Mn source reagent) were prepared respectively in a predetermined amount so that a total element molar ratio of Li, Ni and Mn is 2:1:3, and a raw material mixture was obtained.

Next, the raw material mixture was pulverized and mixed in a mortar, after that, further pulverized and mixed under conditions of 300 rpm for six hours by a planetary ball mill. At this time, 5 mm zirconia balls and ethanol as a dispersion liquid were added. A weight ratio of the raw material mixture, the 5 mm zirconia balls, and ethanol was set to 4:7:11. After the end of pulverization and mixing, the zirconia balls were removed, and a pulverized and mixed raw material mixture was vacuum-dried at 80° C. After that, a dried, pulverized, and mixed raw material mixture was heated to 900° C. in air by a tubular furnace. At this time, the temperature increase rate was set to 30° C./min. After the temperature reached 900° C., a sintered mixture was cooled to 600° C. at the temperature decrease rate of 10° C./min and heated at 600° C. for 24 hours. Thereafter, by naturally cooling to room temperature, a LiNi_{0.5}Mn_{1.5}O₄ base was obtained. A specific surface area was 5.2 m²/g (an area-equivalent diameter is about several micrometers).

A cathode material obtained by coating a thin film of conductive polymer polythiophene doped with BF₄ on the LiNi_{0.5}Mn_{1.5}O₄ base was prepared according to the following procedure.

Into 5% by weight hydrogen peroxide water, 18.69 g of the LiNi_{0.5}Mn_{1.5}O₄ base was immersed, allowed to be oxidized for 4 hours while stirring by a magnetic stirrer, after being cleansed with distilled water, filtered, and vacuum-dried at 80° C. The base after vacuum-drying was immersed in 100 ml of a 2 mol/L LiBF₄ solution obtained by dissolving LiBF₄ in propylene carbonate, and 1.83 g of thiophene was added. After that, the base was cleansed with acetone and vacuum-dried at 80° C., thus a cathode material coated with a thin layer of conductive polymer polythiophene doped with BF₄⁻ was obtained.

A carbon content N_{c} in the cathode material of Example 1 was 6.1% by mass. Further, a specific surface area by a nitrogen absorption BET multipoint method was 5.29 m²/g (an area-equivalent diameter was about several micrometers).

A polythiophene content is estimated from the carbon content according to the following procedure. A molecular formula of polythiophene is represented by (C₄H₂S)ₙ. Here, n denotes a degree of polymerization. That is, a mole ratio in the polythiophene is C:H:S=4:2:1. Molecular weights of carbon (C), hydrogen (H) and sulfur (S) are Mw_{C}=12, Mw_{H}=1, and Mw_{S}=30, respectively, and, a hydrogen content N_{H} and a sulfur content N_{S} are calculated from the following formulas (1) and (2) to be the hydrogen content N_{H}=0.25% by mass and the sulfur content N_{S}=3.8% by mass.

N_{H}=(2×N_{C}×Mw_{H})/(4×Mw_{c}) Formula (1):

N_{S}=(1×N_{C}×Mw_{S})/(4×Mw_{c}) Formula (2):

From the formulas (1) and (2) described above, when a dope amount of BF₄⁻ is set to a % by mass, a content N of the polythiophene and BF₄⁻ is calculated from the following formula (3) to be 10.2+α% by mass.

N=N_{C}+N_{H}+N_{S}+α Formula (3):

To the cathode material described above, N-methylpyrrolidone (NMP) as a dispersion solvent, acetylene black as a conductive auxiliary agent and PVDF (#9130 manufactured by Kureha Chemical Industry Co., Ltd.) as a binder were added at a mass ratio of cathode material: conductive auxiliary agent:binder=90:5:5, the mixture was diluted and mixed with the dispersion solvent, and a coating liquid was prepared. This coating liquid was coated on an aluminum foil using an automatic coating machine (applicator) manufactured by HOUSEN, then dried and pressed, and a cathode mixture electrode having a supported amount of electrode of about 8 mg/cm² was prepared. Further, the cathode mixture electrode was incorporated while facing a metal Li foil negative electrode via a porous polyolefin separator, an electrolyte solution obtained by mixing ethylene carbonate and ethyl methyl carbonate at a mass ratio of 3:7 and by dissolving 1 M of LiPF₆ therein was added, and a 2032 type coin battery was prepared.

Incidentally, in Example 1, after hydrogen peroxide water as an oxidant was brought into contact with the electrode active material LiNi_{0.5}Mn_{1.5}O₄ base to partially oxidize the electrode active material, a solution obtained by dissolving thiophene that is a monomer and an electrolyte LiBF₄ that is a salt of a dopant negative ion BF₄⁻ and a Li⁺ ion was brought into contact with an entire surface of the electrode active material, thus, while doping the BF₄⁻, the thiophene was oxidized and polymerized, and surfaces of primary particles of the electrode active material base were coated with a layer that contains the polythiophene that is a conductive polymer and a negative ion BF₄⁻.

In place of the production procedure described above, thiophene or a solution obtained by dissolving, for example, a thiophene-related substance that has the adhesiveness to the electrode active material LiNi_{0.5}Mn_{1.5}O₄ base is brought into contact with the electrode active material to allow an entire surface of the electrode active material to adsorb the thiophene or the thiophene-related substance, thereafter, by bringing a solution in which an oxidant such as hydrogen peroxide water having oxidizing power capable of oxidizing and polymerizing the thiophene or the thiophene-related substance and a dopant negative ion such as BF₄⁻(or, preferably, LiBF₄⁻ that is a salt with Li) are dissolved into contact with an entire surface of the electrode active material, while doping the dopant negative ion BF₄⁻, the thiophene or the thiophene-related substance is oxidized and polymerized, thus, surfaces of primary particles of the electrode active material may be coated with a layer that contains the conductive polymer polythiophene or a polymer of the related substance and the dopant negative ion such as BF₄⁻.

### Comparative Example 1

A cathode material of Comparative Example 1 was obtained from the LiNi_{0.5}Mn_{1.5}O₄ base of Example 1 without applying the conductive polymer.

Firstly, the Li source reagent, the Ni source reagent and the Mn source reagent were prepared respectively in a predetermined amount so that a total element molar ratio of Li, Ni and Mn is 2:1:3, and a raw material mixture was obtained.

Next, the raw material mixture was pulverized and mixed in a mortar, after that, pulverized and mixed under conditions of 300 rpm for six hours by a planetary ball mill. At this time, 5 mm zirconia balls and ethanol as a dispersion liquid were added. A weight ratio of the raw material mixture, the 5 mm zirconia balls, and ethanol was set to 4:7:11. After the end of pulverization and mixing, the zirconia balls were removed and a pulverized and mixed raw material mixture was vacuum-dried at 80° C. After that, a dried, pulverized, and mixed raw material mixture was heated to 900° C. in air by a tubular furnace. At this time, the temperature increase rate was set to 30° C./min. After the temperature reached 900° C., a sintered mixture was cooled to 600° C. at the temperature decrease rate of 10° C./min and heated at 600° C. for 24 hours. Thereafter, the sintered mixture was cooled to room temperature by natural cooling, and a LiNi_{0.5}Mn_{1.5}O₄ base was obtained. A specific surface area was 5.2 m²/g (an area-equivalent diameter is about several micrometers).

To the cathode material described above, N-methylpyrrolidone (NMP) as a dispersion solvent, acetylene black as a conductive auxiliary agent and PVDF (#9130 manufactured by Kureha Chemical Industry Co., Ltd.) as a binder were added at a mass ratio of cathode material:conductive auxiliary agent:binder=90:5:5, the mixture was diluted and mixed with the dispersion solvent, and a coating liquid was prepared. This coating liquid was coated on an aluminum foil using the automatic coating machine (applicator) manufactured by Hosen, then dried and pressed, and a cathode mixture electrode having a supported amount of electrode of about 8 mg/cm² was prepared. Further, the cathode mixture electrode was incorporated while facing the metal Li foil negative electrode via the porous polyolefin separator, an electrolyte solution obtained by mixing ethylene carbonate and ethyl methyl carbonate at a mass ratio of 3:7 and by dissolving 1 M of LiPF₆ therein was added, and a 2032 type coin battery was prepared.

### Evaluation of Rate Characteristics of Coin Batteries of Example 1 and Comparative Example 1

At 25° C., the coin batteries of Example 1 and Comparative Example 1 were, after a constant current charge up to 5.0 V at 0.1 C, subjected to a constant voltage charge at 5.0 V, and, after that, to a charge to 3.0 V at 0.1 C. Subsequently, the constant current charge and constant voltage charge were performed under the same conditions, the sequential constant current discharges were performed at 1 C,5 C and 10 C, and the rate characteristics were measured.

These results are shown in the following Table 1 (discharge capacities for each rate of Example 1 and Comparative Example 1) and the following Table 2 (difference(unit: V) between a charge voltage and a discharge voltage of Example 1 and Comparative Example 1 at discharge capacity 70 mAh/g).

TABLE 1

| | 0.1 C | 1 C | 5 C | 10 C |
|---|---|---|---|---|
| Example 1 | 117.8 | 116.6 | 105.1 | 86.7 |
| Comparative | 139.7 | 129.3 | 105.9 | 80.7 |
| Example 1 | | | | |

TABLE 2

| | 0.1 C | 1 C | 5 C | 10 C |
|---|---|---|---|---|
| Example 1 | 0.08 | 0.19 | 0.49 | 1.12 |
| Comparative | 0.03 | 0.14 | 0.60 | 1.36 |
| Example 1 | | | | |

From Table 1, the coin battery of Example 1 was smaller in the discharge capacity than the coin battery of Comparative Example 1 at a low rate from 0.1 C to 5 C, but reversed and became larger in the discharge capacity than Comparative Example 1 at high rate 10 C, and exhibited excellent high-output followability at a particularly high rate.

Further, from Table 2, the coin battery of Example 1 was larger in the potential difference between charge and discharge than the coin battery of Comparative Example 1 at 0.1 C, but became smaller in the potential difference between charge and discharge than Comparative Example 1 as the rate increases from 1 C to 5 C to 10 C, and exhibited a tendency of suppressing an increase in polarization at a particularly high rate.

From results described above, it is found that when the electrode active material base of LiNi_{0.5}Mn_{1.5}O₄ was coated with a thin layer of conductive polymer polythiophene containing BF₄⁻ as the dopant, the polarization in a particularly high rate region decreased and the high-rate followability was improved in comparison with an uncoated active material base. This is considered because due to the coating of the layer, the electron conductivity was imparted and a Li ion conduction path was formed.

### Evaluation of Cycle Characteristics of Coin Batteries of Example 1 and Comparative Example 1

The coin batteries of Example 1 and Comparative Example 1 were subjected, at 25° C., to constant current charge to 5.0 V at 1 C and, after that, to discharge to 3.0 V at 1 C. This charge/discharge was repeated and the cycle characteristics were measured.

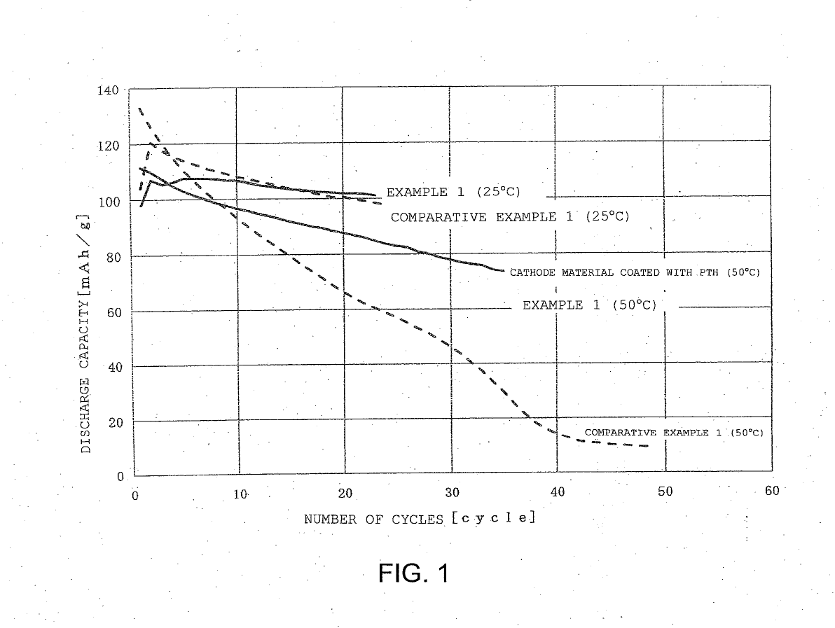

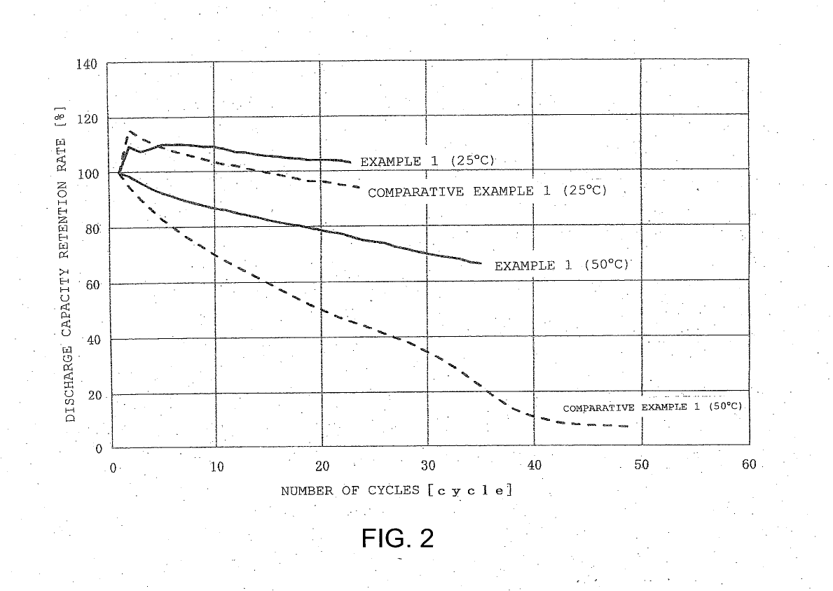

Results thereof are shown in FIG. 1 and FIG. 2.

From FIG. 1, at 25° C., a discharge capacity of the coin battery of Example 1 was smaller than the discharge capacity of the coin battery of Comparative Example 1 from 1 to 16 cycles, but after that, it reversed and became larger than that of Comparative Example 1. Results at 50° C. were more remarkable, that is, the discharge capacity of the coin battery of Example 1 was smaller than the coin battery of Comparative Example 1 from 1 to 9 cycles, but, after that, while the discharge capacity rapidly decreased in Comparative Example 1, Example 1 was suppressed from decreasing in the capacity, and exhibited more excellent characteristics.

Further, from FIG. 2, at 25° C., a discharge capacity retention rate of the coin battery of Example 1 was smaller than the discharge capacity retention rate of the coin battery of Comparative Example 1 from 1 to 5 cycles, but after that, it reversed and became larger than that of Comparative Example 1. In particular, at 50° C., the discharge capacity retention rate of the coin battery of Example 1 became larger than the discharge capacity retention rate of the coin battery of Comparative Example 1 at 2 cycles and later and, as the cycle goes on, the difference therebetween remarkably increased.

From results described above, it is found that when the electrode active material base of LiNi_{0.5}Mn_{1.5}O₄ was coated with a thin layer of conductive polymer polythiophene containing BF₄⁻ as the dopant, the discharge capacity retention rate is suppressed from decreasing as the cycle goes on in comparison with that of an uncoated active material base, and, it is found that there is a remarkable improvement in the cycle charge/discharge, in particular, at high temperatures.

In the electrode active material LiNi_{0.5}Mn_{1.5}O₄ having a very high redox potential such as about 4.7 V, it is necessary to apply a very high voltage (5 V was adopted in Example 1 and Comparative Example 1) at the time of charge. In the case of such high voltage charge, it is known that side reactions such as the oxidative decomposition of the electrolyte solution and the elution of the transition metal component in the cathode material into the electrolyte solution are likely to occur and become remarkable at high temperatures in particular. In FIG. 1 and FIG. 2 described above, the cycle deterioration behavior of Comparative Example 1 is considered to reflect these.

Contrary to this, a remarkable improvement in the cycle characteristics of the cathode material of Example 1 in FIG. 1 and FIG. 2 is inferred to be a result in which by coating a thin layer of the conductive polymer polythiophene containing BF₄⁻ as the dopant negative ion, side reactions such as the oxidative decomposition of the electrolyte solution and the elution of the transition metal component in the cathode material into the electrolyte solution are suppressed.

Incidentally, according to a producing method described in Example 1, an estimated coating amount of the BF₄⁻-doped conductive polymer polythiophene thin layer was relatively slight such as about 10% by mass as described above. However, from suppression effect of cycle degradation in FIG. 1 and FIG. 2, it is inferred that the surface of the LiNi_{0.5}Mn_{1.5}O₄ electrode active material base was substantially densely coated and a direct contact of the electrode active material with the electrolyte solution was avoided. Further, the LiNi_{0.5}Mn_{1.5}O₄ electrode active material illustrated in Example 1 was synthesized by a solid phase sintering of raw materials in air. Therefore, the conductivity cannot be imparted by carbon coating or the like due to the thermal decomposition of a carbon precursor, which necessitates an inert gas atmosphere. On the contrary, in the thin layer coating of the BF₄⁻-doped conductive polymer, which was described in Example 1, irrespective of the producing method of the active material base, both the electron conductivity and the Li ion conductivity can be imparted.

Further, in Example 1, also a cathode material coated with the conductive polymer that does not contain the dopant negative ion was produced together without adding the LiBF₄ dissolved in the propylene carbonate, by bringing thiophene alone into contact to oxidize and polymerize thiophene, after that, by cleansing with acetone, and by vacuum-drying at 80° C., the charge/discharge characteristics were similarly evaluated. As a result, also in the cathode material that does not contain the dopant negative ion, in the same manner as Example shown in FIG. 1 and FIG. 2, the charge/discharge cycle characteristics at 25° C. and 50° C. were improved compared with Comparative Example 1.

It is considered that in the Example, when charging was applied after incorporation of the cathode material in the coin battery, PF₆⁻ that is a negative ion of LiPF₆ used as the electrolyte was doped in the polythiophene coating layer, the conductivity and the Li ion conductivity were imparted, and the characteristics described above were obtained thereby.

### Example 2

Hereinafter, a producing method according to Example 2 will be described.

In [Example 1] and [Comparative Example 1], LiNi_{0.5}Mn_{1.5}O₄ base of disordered type (sites of Ni and Mn in a crystal are mixed, and defects of O (oxygen) are relatively abundant) was used, in the Example 2, a LiNi_{0.5}Mn_{1.5}O₄ base of ordered type (sites of Ni and Mn in a crystal are substantially independent and defects of oxygen are scarce) that is obtained by varying the sintering condition was used. At first, the LiNi_{0.5}Mn_{1.5}O₄ base of the ordered type was produced according to the following procedure.

Firstly, the reagent Li₂CO₃ (hereinafter, referred to as a Li source reagent) , Ni (NO₃)₂.6H₂O (hereinafter, referred to as a Ni source reagent) and the reagent MnO₂ (hereinafter referred to as Mn source reagent) were prepared respectively in a predetermined amount such that a total element molar ratio of Li, Ni and Mn is 2:1:3, and a raw material mixture was obtained.

Next, the raw material mixture was pulverized and mixed in a mortar, after adding 5 mm zirconia balls and ethanol as a dispersion liquid therein, further pulverized and mixed under conditions of 300 rpm for six hours by a planetary ball mill. At this time, a weight ratio of the raw material mixture, 5 mm zirconia balls and ethanol was set to 4:7:11 by a weight ratio. After the end of pulverization and mixing, the zirconia balls were removed, and a pulverized and mixed raw material mixture was vacuum-dried at 80° C. After that, a dried, pulverized, and mixed raw material mixture was heated to 900° C. at the temperature increase rate of 30° C./min in air by a tubular furnace, held at 900° C. for 6 hours after reaching 900° C., thereafter, cooled to room temperature by natural cooling. After pulverizing a sintered raw material mixture, it was heated to 700° C. at the temperature increase rate of 30° C./min in air by a tubular furnace, held at 700° C. for 12 hours after reaching 700° C., thereafter, cooled by natural cooling, and an ordered LiNi_{0.5}Mn_{1.5}O₄ base was obtained.

A cathode material obtained by coating a thin layer of the conductive polymer polythiophene on the LiNi_{0.5}Mn_{1.5}O₄ base was prepared according to the following procedure.

In a solution obtained by dissolving 0.9 g of thiophene that becomes a raw material of polythiophene, 14.25 g of the LiNi_{0.5}Mn_{1.5}O₄ base was immersed, and a mixture was mixed for 30 minutes by a magnet stirrer. The mixture was immersed in 5% by weight hydrogen peroxide water and allowed to be oxidized for 3 hours in a magnet stirrer, vacuum-dried at 80° C., and a cathode material coated with a thin layer of the conductive polymer polythiophene was obtained.

In this process, a large part of the thiophene is oxidized and polymerized in an adsorbed state on the LiNi_{0.5}Mn_{1.5}O₄ base and coats the surface of the base as polythiophene because the thiophene does not dissolve in the hydrogen peroxide water (aqueous liquid phase) and remains on a surface of the LiNi_{0.5}Mn_{1.5}O₄ base.

Incidentally, a precursor thiophene of the polythiophene was brought into contact here as an ethanol solution. However, since the thiophene itself is a liquid, without forming into a solution, the thiophene itself can be used by immersing in and contacting with the active material base as it is. This is common also in the case where a polymerization precursor (monomer or oligomer) of other conductive polymer is used.

When the content of polythiophene in the cathode material of Example 2 was calculated in the same manner as the case of Example 1, it was found to be 0.62% by mass.

To the cathode material described above, N-methylpyrrolidone (NMP) as a dispersion solvent, acetylene black as a conductive auxiliary agent and PVDF (#9130 manufactured by Kureha Chemical Industry Co., Ltd.) as a binder were added at a mass ratio of cathode material:conductive auxiliary agent:binder=86.2:6.8:7.0, and a coating liquid diluted and mixed with the dispersion solvent was prepared. This coating liquid was coated on an aluminum foil using an automatic coating machine (applicator) manufactured by Hosen, dried and pressed, and a cathode mixture electrode having a supported amount of cathode of about 8 mg/cm² was prepared. Further, the cathode mixture electrode was incorporated while facing the metal Li foil negative electrode via the porous polyolefin separator, an electrolyte solution obtained by mixing ethylene carbonate and ethyl methyl carbonate at a mass ratio of 1:1 and by dissolving 1 M of LiPF₆ therein was added, and a 2032 type coin battery was prepared.

### Comparative Example 2

The cathode material of Comparative Example 2 is the ordered LiNi_{0.5}Mn_{1.5}O₄ base itself of Example 2 and was obtained without coating the conductive polymer. With this cathode material, a coin battery was prepared in the same manner as Example 2.

### Evaluation of Rate Characteristics of Coin Batteries of Example 2 and Comparative Example 2

At 25° C., the coin battery of Example 2 was subjected to a constant current charge to 5.0 V at 0.1 C, after that, to a constant voltage charge at 5.0 V, thereafter, to discharge to 3.0 V at 0.1 C. Subsequently, the constant current charge and constant voltage charge were performed under the same conditions as the above, the sequential constant current discharges were performed at 1 C,5 C and 10 C, and the rate characteristics were measured. The discharge capacities at the time of discharge at 0.1 C, 1 C, 5 C and 10 C were 138.8, 128.9, 109.1 and 91.6 mAh/g, respectively.

### Evaluation of Cycle Characteristics of Coin Batteries of Example 2 and Comparative Example 2

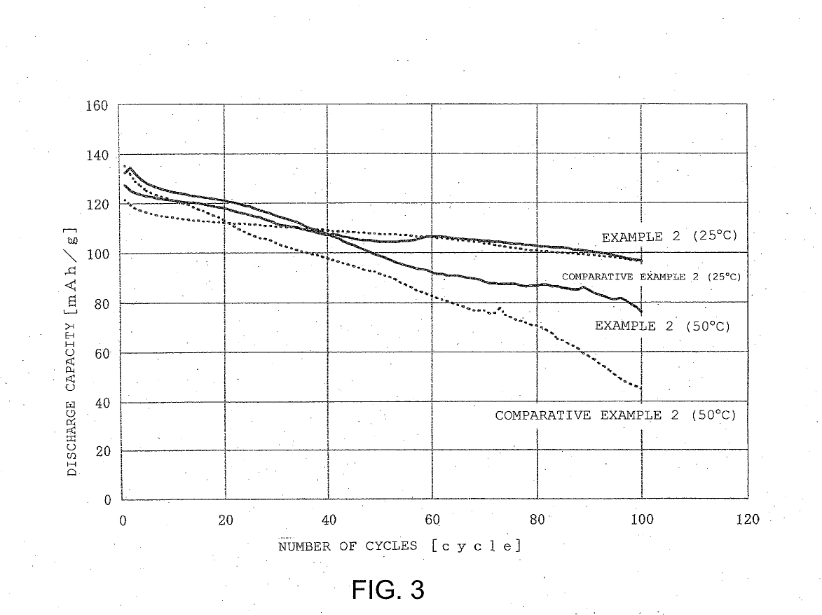

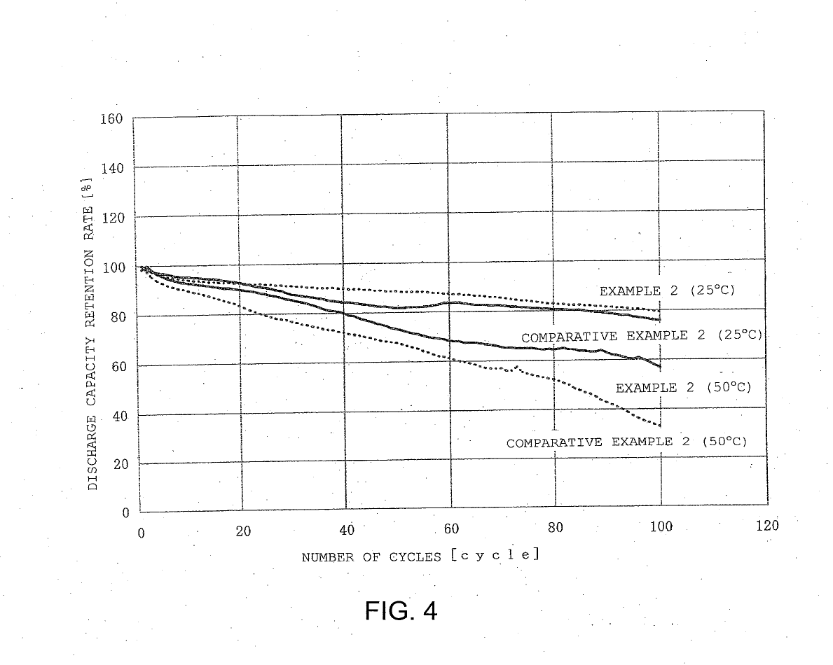

At 25° C. and 50° C., the coin batteries of Example 2 and Comparative Example 2 were subjected to a constant current charge to 5.0 V at 1 C, after that, to discharge to 3.0 V at 1 C. The charge/discharge was repeated and the cycle characteristics were measured. These results are shown in FIG. 3 and FIG. 4.

From FIG. 3, at 25° C., the discharge capacities of Example 2 and Comparative Example 2 exhibited substantially the same characteristics. Further, at 50° C., at 2 cycles and later, the discharge capacity of Example 2 exhibited more excellent characteristics than the characteristics of Comparative Example 2. At the time of 100 cycles, Example 2 exhibited 76.3 mAh/g and Comparative Example 2 exhibited 44.8 mAh/g, that is, Example 2 exhibited more excellent discharge capacity.

From FIG. 4, at 25° C., the discharge capacity retention rates of Example 2 and Comparative Example 2 exhibited substantially the same characteristics. At 50° C., at 2 cycles and later, the discharge capacity of Example 2 exhibited more excellent characteristics than the characteristics of Comparative Example 2. At the time of 100 cycles, Example 2 exhibited 56.7% and Comparative Example 2 exhibited 33.1%, that is, Example 2 exhibited more excellent discharge capacity retention rate.

Incidentally, in a production step of the cathode material in Example 2, the negative ion doping such as that applied in Example 1, which imparts the conductivity and Li ion conductivity to a polythiophene coating layer was omitted. However, it is considered that the characteristics described above were obtained because when charge was applied after incorporation of the cathode material into the coin battery, PF₆⁻ that is a negative ion of LiPF₆ used as an electrolyte was doped in the polythiophene coating layer, and the conductivity and the Li ion conductivity were imparted.

Further, in the production step of the cathode material described above in Example 2, in order to impart the conductivity and the Li ion conductivity to the polythiophene coating layer, by oxidizing and polymerizing thiophene by adding the electrolyte containing the dopant negative ion (BF₄⁻ and the like) such as LiBF₄ or the like in an ethanol solution in which the thiophene was dissolved and/or hydrogen peroxide water, the surface of the cathode active material can be coated while doping the dopant negative ion.

1. A cathode material for secondary batteries comprising:
an electrode active material base containing Li, wherein
the electrode active material base is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g, and
surfaces of primary particles of the electrode active material base are coated with a layer containing a conductive polymer and negative ions which enable the conductive polymer to produce electron conductivity equal to or higher than the electron conductivity of the electrode active material itself.

2. The cathode material for secondary batteries according to claim 1 characterized in that the electrode active material base is capable of the electrode oxidation/reduction accompanied by desorption and absorption of Li ions in the potential range of 4.3 V or more and 5 V or less based on a metal Li negative electrode and has a reversible charge/discharge capacity accompanying the electrode oxidation/reduction in the potential range described above of 30 mAh or more per 1 g.

3. The cathode material for secondary batteries according to claim 1 characterized in that the conductive polymer is at least one of polyaniline, polypyrrole, and polythiophene.

4. The cathode material for secondary batteries according to claim 1 characterized in that the negative ion is at least one of BF₄⁻ and PF₆⁻.

5. The cathode material for secondary batteries according to claim 1 characterized in that the electrode active material base containing Li is at least one of a metal phosphate having an olivine crystal structure, a metal oxide having a spinel crystal structure and a metal oxide having a layered crystal structure.

6. The cathode material for secondary batteries according to claim 5 characterized in that the metal phosphate having an olivine crystal structure is represented by a formula LiMPO₄, where M represents at least one of Mn and Co, or a combination of at least one of Mn and Co and at least one of Fe and Ni.

7. The cathode material for secondary batteries according to claim 5 characterized in that the metal phosphate having an olivine crystal structure is represented by a formula LiFeᵤMnᵥCo₁₋ᵤ₋ᵥPO₄, where u represents a number of 0 or more and 0.5 or less, v represents a number of 0 or more and 1 or less, and u+v is 1 or less.

8. The cathode material for secondary batteries according to claim 5 characterized in that the metal oxide having a spinel crystal structure is represented by a formula LiNiₜM′ₓMn₂₋ₜ₋ₓO₄, where M′ represents at least one of Fe, Co, Cr and Ti, t represents a number of 0 or more and 0.6 or less, x represents a number of 0 or more and 0.6 or less, and t +x is 0.8 or less.

9. The cathode material for secondary batteries according to claim 5 characterized in that the metal oxide having a spinel crystal structure is represented by a formula LiNi_{0.5}Mn_{1.5}O₄.

10. The cathode material for secondary batteries according to claim 5 characterized in that the metal oxide having a layered crystal structure is represented by a formula LiM″O₂, where M″ represents at least one of Mn, Co and Ni, or a combination of at least one of Mn, Co and Ni and Al.

11. A cathode material for secondary batteries comprising;
an electrode active material base containing Li, wherein
the electrode active material base is capable of an electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g, and
surfaces of primary particles of the electrode active material base are coated with a layer containing a conductive polymer.

12. The cathode material for secondary batteries according to claim 11 characterized in that the electrode active material base is capable of the electrode oxidation/reduction accompanied by desorption and absorption of Li ions in a potential range of 4.3 V or more and 5 V or less based on the metal Li negative electrode and has a reversible charge/discharge capacity accompanying the electrode oxidation/reduction in the potential range described above of 30 mAh or more per 1 g.

13. The cathode material for secondary batteries according to claim 11 characterized in that the conductive polymer is at least one of polyaniline, polypyrrole, and polythiophene.

14. The cathode material for secondary batteries according to claim 11 characterized in that the electrode active material base containing Li is at least one of a metal phosphate having an olivine crystal structure, a metal oxide having a spine! crystal structure and a metal oxide having a layered crystal structure.

15. The cathode material for secondary batteries according to claim 14 characterized in that the metal phosphate having an olivine crystal structure is represented by a formula LiMPO₄ where, M represents at least one of Mn and Co, or a combination of at least one of Mn and Co and at least one of Fe and Ni).

16. The cathode material for secondary batteries according to claim 14 characterized in that the metal phosphate having an olivine crystal structure is represented by a formula LiFeᵤMnᵥCo₁₋ᵤ₋ᵥPO₄, where u represents a number of 0 or more and 0.5 or less, v represents a number of 0 or more and 1 or less, and u+v is 1 or less).

17. The cathode material for secondary batteries according to claim 14 characterized in that the metal oxide having a spinel crystal structure is represented by a formula LiNiₜM′ₓMn₂₋ₜ₋ₓO₄, where M′ represents at least one of Fe, Co, Cr and Ti, t represents a number of 0 or more and 0.6 or less, x represents a number of 0 or more and 0.6 or less, and t+x is 0.8 or less).

18. The cathode material for secondary batteries according to claim 14 characterized in that the metal oxide having a spinel crystal structure is represented by a formula LiNi_{0.5}Mn_{1.5}O₄.

19. The cathode material for secondary batteries according to claim 14 characterized in that the metal oxide having a layered crystal structure is represented by a formula LiM″O₂, where M″ represents at least one of Mn, Co and Ni, or a combination of at least one of Mn, Co and Ni and Al).

20. The cathode material for secondary batteries according to claim 11 characterized in that after the cathode material for secondary batteries is incorporated in a lithium secondary battery, in a process of charging the lithium secondary battery, a negative ion that is a negative ion in an electrolyte of the lithium secondary battery and enables the conductive polymer to produce electron conductivity equal to or higher than the electron conductivity of the electrode active material itself is doped in the conductive polymer.

21. A method for producing a cathode material for secondary batteries characterized by including the steps of:
oxidizing a part of an electrode active material by bringing a solution in which an oxidant that has oxidation power capable of at least partially oxidizing the electrode active material and capable of oxidizing and polymerizing a monomer or an oligomer to be a raw material of a conductive polymer is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and
thereafter, coating surfaces of primary particles of the electrode active material with a layer that contains the conductive polymer and a negative ion by oxidizing and polymerizing the monomer or oligomer while doping the negative ion by bringing a solution in which the monomer or oligomer and the negative ion are dissolved into contact with the entire surface of the electrode active material.

22. A method for producing a cathode material for secondary batteries characterized by including the steps of:
allowing an entire surface of an electrode active material to adsorb a monomer or oligomer by bringing a solution in which the monomer or oligomer to be a raw material of a conductive polymer is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and,
thereafter, coating surfaces of primary particles of the electrode active material with a layer containing the conductive polymer and a negative ion by oxidizing and polymerizing the monomer or oligomer while doping the negative ion by bringing a solution in which an oxidant having oxidizing power capable of oxidizing and polymerizing the monomer or oligomer and the negative ion that enable the conductive polymer to produce electron conductivity equal to or higher than the electron conductivity of the electrode active material itself are dissolved into contact with the entire surface of the electrode active material.

23. A method for producing a cathode material for secondary batteries characterized by including the steps of:
oxidizing a part of an electrode active material by bringing an oxidant that has oxidation power capable of at least partially oxidizing the electrode active material and capable of oxidizing and polymerizing a monomer or an oligomer to be a raw material of a conductive polymer or a solution in which the oxidant is dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and,
thereafter, coating surfaces of primary particles of the electrode active material with a layer that contains the conductive polymer by oxidizing and polymerizing the monomer or oligomer by bringing a solution in which any one of the monomer or oligomer or the monomer and oligomer are dissolved into contact with the entire surface of the electrode active material.

24. A method for producing a cathode material for secondary batteries characterized by including the steps of:
allowing an entire surface of an electrode active material to adsorb a monomer or oligomer by bringing a solution in which the monomer or oligomer, or the monomer and oligomer to be a raw material of a conductive polymer are dissolved into contact with an entire surface of the electrode active material containing Li, which is capable of electrode oxidation/reduction accompanied by desorption and absorption of Li ions in a potential range of 4 V or more and 5 V or less based on a metal Li negative electrode and has a reversible charge/discharge capacity accompanying the electrode oxidation/reduction in the potential range described above of 30 mAh or more per 1 g; and,
thereafter, coating surfaces of primary particles of the electrode active material with a layer containing the conductive polymer by oxidizing and polymerizing the monomer or oligomer by bringing an oxidant having oxidizing power capable of oxidizing and polymerizing the monomer or oligomer or a solution in which the oxidant is dissolved into contact with the entire surface of the electrode active material.

25. The method for producing a cathode material for secondary batteries according to claim 23 characterized by further including the step of:
coating surfaces of primary particles of the electrode active material with a layer containing the conductive polymer and the negative ions by oxidizing and polymerizing the monomer or oligomer while doping the negative ions by making a negative ion that enables the conductive polymer to produce electron conductivity equal to or higher than the electron conductivity of the electrode active material itself coexist on an entire surface of the electrode active material when the monomer or oligomer is oxidized and polymerized.

26. The method for producing a cathode material for secondary batteries according to claim 23 characterized by further including the step of:
doping the negative ion that is a negative ion in an electrolyte of the lithium secondary battery and enables the conductive polymer to produce electron conductivity equal to or higher than the electron conductivity of the electrode active material itself in a charging process of the lithium secondary battery, after the cathode material for secondary batteries is incorporated in the lithium secondary battery.

27. A secondary battery characterized by including the cathode material for secondary batteries according to claim 1, or the cathode material for secondary batteries produced by the producing method according to claim 21, as one of constituent members.
